(19) United States
(12) Patent Application Publication
(10) Pub. No.: US 2013/0007206 A1
(43) Pub. Date: Jan. 3, 2013

(54) TRANSMISSION APPARATUS, CONTROL METHOD FOR TRANSMISSION APPARATUS, AND STORAGE MEDIUM

(75) Inventor: Shun Sugimoto, Tokyo (JP)

(73) Assignee: CANON KABUSHIKI KAISHA, Tokyo (JP)

(21) Appl. No.: 13/531,926

(22) Filed: Jun. 25, 2012

(30) Foreign Application Priority Data
Jun. 28, 2011 (JP) 2011-142996

(51) Int. Cl. G06F 15/16

(52) U.S. Cl. 709/217

(57) ABSTRACT

A transmission apparatus includes a transmission unit configured to transmit content data, a receiving unit configured to receive a type of content data from a receiving apparatus, a load determination unit configured to determine a load for processing content data of the type received from the receiving apparatus according to a data amount transmitted from the transmission unit for the content data of the type received from the receiving apparatus, and a transmission determination unit configured to determine whether to transmit the content data of the type received from the receiving apparatus to the receiving apparatus based on the load determined by the load determination unit regarding the content data of the type received from the receiving apparatus.

### BACKGROUND OF THE INVENTION

1. Field of the Invention

The present invention relates to a transmission apparatus for transmitting data and a control method for the transmission apparatus.

2. Description of the Related Art

Today, media transmission using Internet Protocol (IP) networks such as the Internet is spread. A Transport Protocol for Real-Time Applications (RTP) has been used. The RTP is a protocol for transmitting media data such as audio and moving images captured by a camera in a real-time manner via a network. Moreover, since devices and network formats for receiving media data have been diversified, there has been a demand for media transmission including transmission of video having various resolutions or coded in different formats.

In real-time transmission of media data, for example, the number of connections needs to be limited in consideration of a processing load of a data transmission apparatus to maintain quality of media at the time of reproduction by a data receiving apparatus.

Japanese Patent Application Laid-Open No. 2004-147343 discusses a method for setting the maximum fixed number of connections beforehand and a method for determining whether to permit a connection in consideration of the current load of a data transmission apparatus based on a central processing unit (CPU) usage rate.

However, there is a possibility that determination of permission or non-permission for content data transmission may not be appropriate for a load of a transmission apparatus for transmitting content data. That is, for example, there are cases where content data corresponding to a request from a receiving apparatus is determined not to be transmitted although the transmission apparatus can transmit the content data corresponding to the request.

Moreover, for example, there is a possibility that content data corresponding to a request from the receiving apparatus is determined to be transmitted although transmission of the content data corresponding to the request may cause an overflow of a buffer.

For example, if each of Motion-JPEG and H.264/AVC encoders encodes data having substantially the same resolution and the same frame rate, the H.264/AVC encoder generally has a higher processing load whereas the Motion-JPEG encoder generally provides a larger amount of generated codes. In addition, if each of data has a different resolution or a frame rate, a processing load and an amount of generated codes differ significantly in spite of the use of the same coding method.

Accordingly, when permission or non-permission for data transmission is determined using the maximum number of connections of the receiving apparatus as a threshold value, there are cases where data transmission is not permitted by the threshold value although the data can be transmitted, or where the data transmission is permitted although the data cannot be transmitted.

### SUMMARY OF THE INVENTION

The present invention is directed to a determination method for determining whether transmission is permitted according to a load of a transmission apparatus.

According to an aspect of the present invention, a transmission apparatus includes a transmission unit configured to transmit content data, a receiving unit configured to receive a type of content data from a receiving apparatus, a load determination unit configured to determine a load for processing content data of the type received from the receiving apparatus according to a data amount transmitted from the transmission unit for the content data of the type received from the receiving apparatus, and a transmission determination unit configured to determine whether to transmit the content data of the type received from the receiving apparatus to the receiving apparatus based on the load determined by the load determination unit regarding the content data of the type received from the receiving apparatus.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a function block diagram illustrating a system according to an exemplary embodiment of the present invention.

FIG. 2 is a flowchart illustrating processing performed by a determination unit according to a first exemplary embodiment.

FIG. 3 is a flowchart illustrating load determination processing according to the first exemplary embodiment.

FIG. 4 is a diagram illustrating one example of a system employing the present invention.

FIG. 5 is a diagram illustrating an initial load amount and a load coefficient according to the first exemplary embodiment.

FIG. 6 is a diagram illustrating an example process performed when a media request is received from a receiving apparatus.

FIG. 7 is a diagram illustrating a change of the number of packets in units of group of pictures (GOP).

FIG. 8 is a flowchart illustrating determination processing of transmission permission/non-permission according to a third exemplary embodiment.

### DESCRIPTION OF THE EMBODIMENTS

Various exemplary embodiments, features, and aspects of the invention will be described in detail below with reference to the drawings. The configurations described in the exemplary embodiments are merely examples, and the present invention is not limited to the configurations illustrated in the drawings.

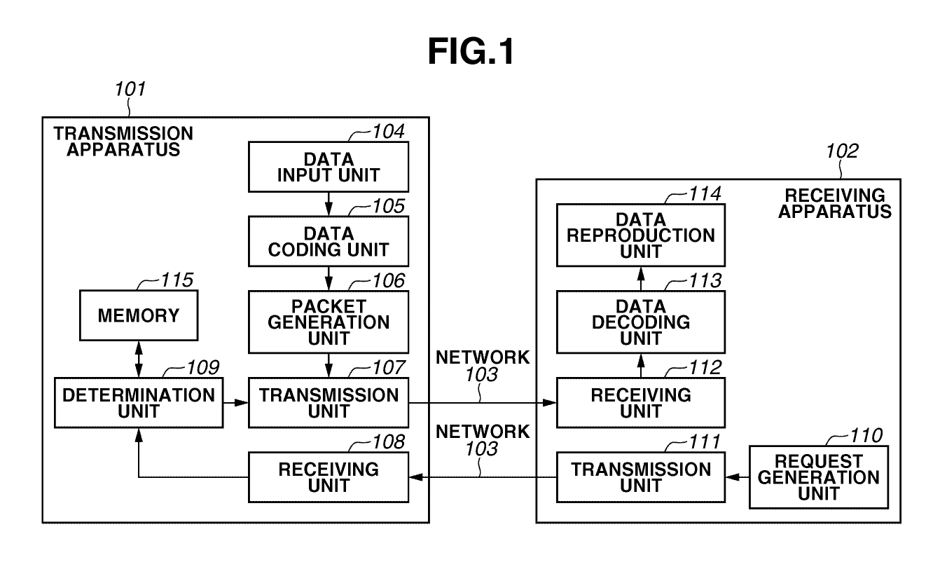

FIG. 1 is a function block diagram illustrating a content data transmission system according to a present exemplary embodiment.

In FIG. 1, a transmission apparatus 101 includes a function of transmitting content data (a content packet). The transmission apparatus 101 can function alone or in combination with a plurality of computer devices. The transmission apparatus 101 can be, for example, a camera having a communication function.

A receiving apparatus 102 includes a function of receiving the content data transmitted by the transmission apparatus 101. The receiving apparatus 102 can function alone or in combination with a plurality of computers. The receiving apparatus 102 can be, for example, a storage device or a television set having a communication function.

In FIG. 1, one transmission apparatus 101 and one receiving apparatus 102 are connected. Alternatively, a plurality of transmission apparatuses 101 and receiving apparatuses 102 may be connected.

The transmission apparatus 101 and the receiving apparatus 102 are connected via a network 103 to be communicable to each other.

The transmission apparatus 101 includes a data input unit 104, a data coding unit 105, a packet generation unit 106, a transmission unit 107, a receiving unit 108, a determination unit 109, and a memory 115.

The receiving apparatus 102 includes a request generation unit 110, a transmission unit 111, a receiving unit 112, a data decoding unit 113, and a data reproducing unit 114.

First of all, a processing flow of the transmission apparatus 101 is now described. The data input unit 104 inputs content data thereto. The present exemplary embodiment is mainly described with respect to an exemplary case in which the content data is video data (video content data). However, the content data may be other types of data such as audio data and text data. The data input unit 104, for example, inputs video data thereto from a video sensor such as a video camera and a network camera, and a storage media. The data input unit 104 inputs the video data to the data coding unit 105.

The data coding unit 105 codes the content data from the data input unit 104 according to a coding method. Herein, the coding method is H.264/AVC or Motion-JPEG, for example. In a case where the content data is audio data, the coding method is G.711 or G726, for example. However, the coding method is not limited to those methods. When the content data is coded by the data coding unit 105, the coded content data is provided to the packet generation unit 106.

The packet generation unit 106 generates a packet (a content packet) suitable for communication from the coded content data. If an RTP is used as a communication protocol, the packet generation unit 106 generally generates an RTP packet of approximately 1500 bytes. The generated content packet is provided to the transmission unit 107. The transmission unit 107 transmits the generated content packet to the receiving apparatus 102 via the network 103.

The receiving unit 108 receives a packet from the receiving apparatus 102 via the network 103. The packet received by the receiving unit 108 includes a content request packet. The content request packet includes type information on the content requested by the receiving apparatus 102.

Such content type information, for example, includes a coding method, a video resolution, or a video frame rate of the content data requested by the receiving apparatus 102 with respect to the transmission apparatus 101. If the requested content data is audio data, for example, the content type information includes information on a coding method or a sampling rate of audio.

The content type information may be information (e.g., 320×240, 640×480) which clearly specifies a type (e.g., resolution) of the content, or may be an identifier (e.g., large, medium, small) by which the transmission apparatus 101 can determine a type of the content. Moreover, the content request packet and the content type information may be transmitted by separate packets.

The determination unit 109 determines whether transmission of the content data corresponding to the content request packet is permitted based on the content type information included in the content request packet received by the receiving unit 108. The determination method is described in detail below.

The transmission unit 107 notifies the receiving apparatus 102 of a result determined by the determination unit 109 as a determination result packet. For example, such determination result packet is transmitted by using a Real Time Streaming Protocol (RTSP) or a Session Initiation Protocol (SIP) as a session control protocol. Alternatively, other protocols may be used.

Next, a processing flow of the receiving apparatus 102 is described. The request generation unit 110 generates the content request packet based on an input by a user of the receiving apparatus 102. The content request packet includes content type information used to specify, for example, a coding method, a resolution, and a frame rate of the content (video data) to be requested from the transmission apparatus 101.

The transmission unit 111 transmits the content request packet generated by the request generation unit 110 to the transmission apparatus 101.

The receiving unit 112 receives various packets including a content packet and a determination result packet. The determination result packet indicates a determination result made by the determination unit 109 of the transmission apparatus 101 whether transmission is permitted.

The transmission unit 111 transmits a transmission request packet for content data to the transmission apparatus 101 when the receiving unit 112 receives the determination result packet indicating the transmission permission by the determination unit 109. A transmission protocol used for the transmission request packet can be the RTSP, the SIP, or other methods.

The data decoding unit 113 decodes the content packet received by the receiving unit 112. The decoded content data is provided to the data reproducing unit 114. The data reproducing unit 114 reproduces such decoded content data.

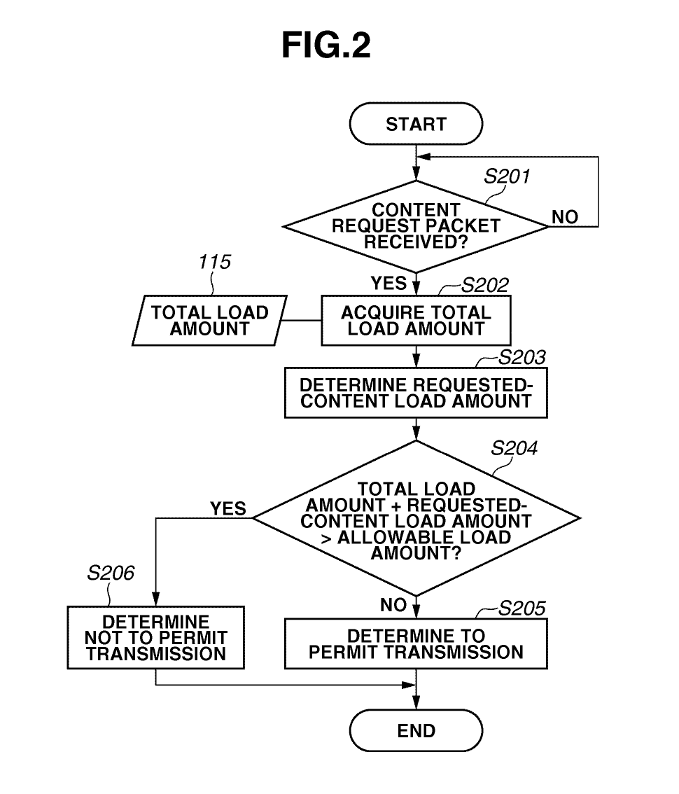

FIG. 2 is a flowchart illustrating a processing flow of the determination unit 109 of the transmission apparatus 101.

The transmission apparatus 101 transmits coded content data to the receiving apparatus 102. The transmission apparatus 101 of the present exemplary embodiment has a CPU, which reads out a program for executing the processing illustrated in FIG. 2 to a random access memory (RAM) and executes the program. However, at least one portion of the processing illustrated in FIG. 2 may be performed by dedicated hardware, for example.

If the determination unit 109 determines that the receiving unit 108 received the content request packet from the receiving apparatus 102 (YES in step S201), the operation proceeds to step S202. The content request packet includes the type information on content. That is, in step S201 (in a receiving step), the receiving unit 108 receives a request including designation of a coding method, a resolution, and a frame rate from the receiving apparatus 102.

However, the content request packet may not necessarily include all of the coding method, the resolution, and the frame rate. Alternatively, the content request packet and a packet for the content type information may be separate packets. Moreover, the content type information can be any information as long as the transmission apparatus 101 can determine a type of content. In addition, the transmission apparatus 101 may provide a default type of content when a content request packet including no type information on content is received.

In step S202, the determination unit 109 acquires the current total load amount from the memory 115.

In step S203, the determination unit 109 determines a load amount (a requested-content load amount) for generation processing and transmission processing on the content data corresponding to the content request packet acquired in step S201 from the content type information included in the content request packet. The current total load amount in step S202 and a method for determining the requested-content load amount in step S203 are described in detail below.

In step S204, the determination unit 109 compares a temporary total load amount with an allowable load amount (a threshold value). The temporary total load amount is the addition of the current total load amount acquired in step S202 to the requested-content load amount determined in step S203.

If the temporary total load amount does not exceed the allowable load amount (NO in step S204), then in step S205, the determination unit 109 determines to permit the transmission. If the temporary total load amount exceeds the allowable load amount (YES in step S204), then in step S206, the determination unit 109 determines not to permit the transmission.

That is, in step S204 (in a determination step), the determination unit 109 uses a load amount corresponding to a designated coding method to determine whether to transmit content data in response to the request received in S201.

In step S205 (in a transmission step), the transmission unit 107 transmits content data coded by the data coding unit 105 to the receiving apparatus 102 according to the determination made by the determination unit 109.

In step S205, the determination unit 109 replaces the total load amount in the memory 115 so that the temporary total load amount should be the current total load amount when transmission is permitted.

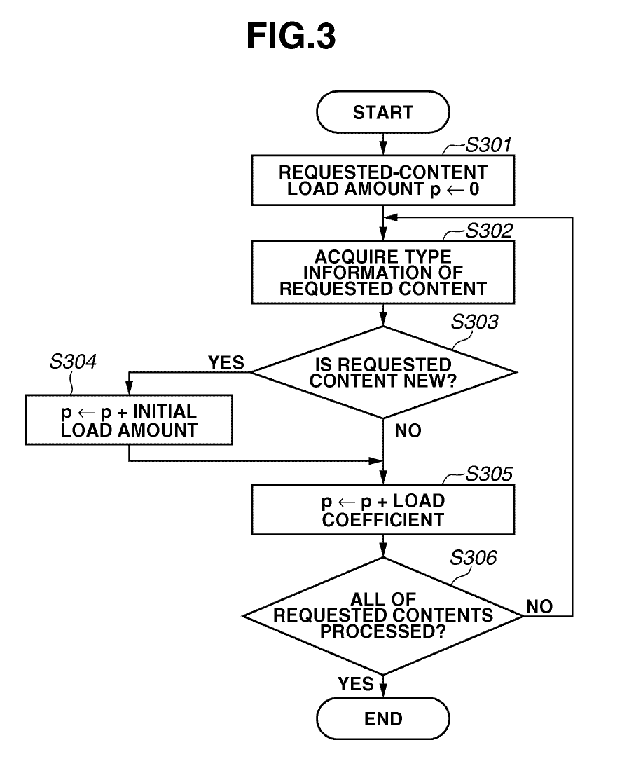

FIG. 3 is a flowchart illustrating processing for determining the requested-content load amount in step S203 of the flowchart illustrated in FIG. 2.

In step S301, the determination unit 109 initializes a requested-content load amount (e.g., assume that a variable is p) serving as an output value of the determination processing to zero.

In step S302, the determination unit 109 acquires type information on the requested content. The type information on the content includes, for example, information such as a coding method, a resolution, and a frame rate of video data.

In step S303, the determination unit 109 determines whether a content packet which has a type corresponding to the content type information is being already transmitted. For example, if a content packet having a type matching the content type information is already transmitted to another receiving device at the time when the content request packet is received from the receiving apparatus 102 in step S201 illustrated in FIG. 2, the determination unit 109 determines that the requested content is not new (NO in step S303).

If the content packet having a type corresponding to the content type information is not being transmitted (YES in step S303), then in step S304, the determination unit 109 adds an initial load amount corresponding to the content type information to a requested-content load amount p. In the present exemplary embodiment, the initial load amount indicates an amount of load for content packet generation processing (e.g., coding processing or packet generation processing). The initial load amount is described in detail below.

In step S305, the determination unit 109 adds a load coefficient corresponding to the content type information to the requested-content load amount P. In the present exemplary embodiment, the load coefficient indicates an amount of load for a content packet transmission. The load coefficient is described in detail below.

In step S306, the determination unit 109 determines whether the processing in step S302 through step S305 is executed as to all of the contents (e.g., video data and audio data) requested from the receiving apparatus 102. If any content remains unprocessed (NO in step S306), the operation returns to step S302.

A description is now given of the entire control flow between the transmission apparatus 101 and the receiving apparatus 102 by referring to a specific example.

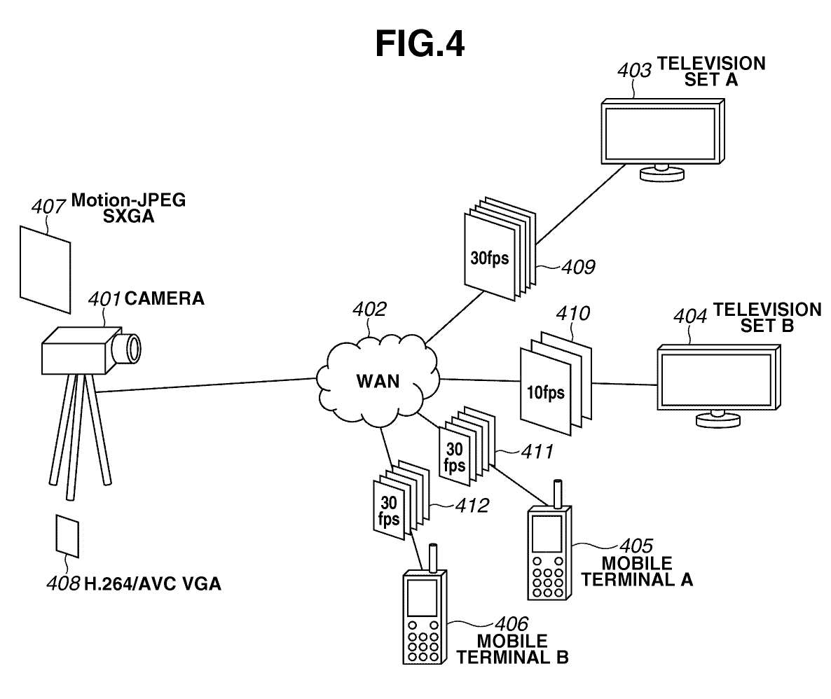

FIG. 4 illustrates a situation where a camera 401 is transmitting video data to a television set A 403, a television set B 404, a mobile terminal A 405, and a mobile terminal B 406 in real time through Internet 402. The camera 401 corresponds to the transmission apparatus 101 illustrated in FIG. 1, whereas each of the television set A 403, the television set B 404, the mobile terminal A 405, and the mobile terminal B 406 corresponds to the receiving apparatus 102 illustrated in FIG. 1.

The data coding unit 105 of the camera 401 includes a plurality of encoders. In FIG. 4, each of a Motion-JPEG (SXGA) encoder 407 and an H.264/AVC (VGA) encoder 408 is being activated. The camera 401 generates the content packet by coding video data (content data) by the respective coding methods, the video data being acquired by capturing video. The transmission unit 107 of the camera 401 transmits the content packet to each of the receiving apparatuses 102 by multi-unicast.

The television set A 403 is receiving video data 409 having a frame rate of 30 frames per second (fps) in Motion-JPEG (SXGA). The television set B 404 is receiving a video packet 410 having a frame rate of 10 fps in Motion-JPEG (SXGA).

The mobile terminal A 405 is receiving video data 411 having a frame rate of 30 fps in H.264/AVC (VGA). Similarly, the mobile terminal B 406 is receiving video data 412 having a frame rate of 30 fps in H.264/AVC (VGA).

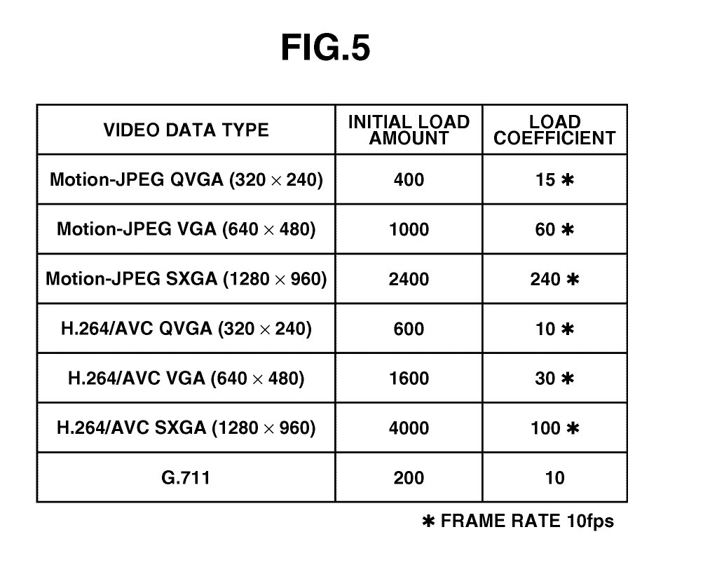

FIG. 5 is a table illustrating an example of an initial load amount and a load coefficient for each content type in the camera 401.

The table illustrated in FIG. 5 is stored in the memory 115 of the camera 401 (the transmission apparatus 101). In the present exemplary embodiment, assume that a sampling rate of G.711 serving as audio data cannot be designated. Thus, FIG. 5 only lists an initial load amount and a load coefficient according to a coding method, a resolution, and a frame rate of video data. However, an initial load amount or a load coefficient according to a type of audio data may be listed.

In FIG. 5, a “VIDEO DATA TYPE” column has a list of a combination of a coding method (Motion-JPEG or H.264/AVC) and a resolution (QVGA, VGA, or SXGA) of video data. As illustrated in FIG. 5, QVGA indicates 320×240 pixels, VGA indicates 640×240 pixels, and SXGA indicates 1280×960 pixels.

As illustrated in FIG. 5, when each of video data has the same resolution, the H.264/AVC method has a higher load than the Motion-JPEG method to generate the content packet. When each of video data has the same resolution, the Motion-JPEG method has a higher load than the H.264/AVC method to transmit the content packet per frame.

The initial load amount illustrated in FIG. 5 corresponds to the load amount for content packet generation in a situation where the frame rate is 30 fps. Therefore, if the frame rate requested from the receiving apparatus 102 is lower than 30 fps, an initial load amount that is lower than that illustrated in FIG. 5 can be set.

If the frame rate requested from the receiving apparatus 102 is higher than 30 fps, on the other hand, an initial load amount that is higher than that illustrated in FIG. 5 can be set.

A description regarding calculation of a total load amount of the camera 401 illustrated in FIG. 4 is given according to the table illustrated in FIG. 5.

In FIG. 4, the camera 401 is transmitting Motion-JPEG (SXGA) video data at a frame rate of 30 fps to the television set A 403. Accordingly, an initial load amount of 2400 and a load coefficient of 240×3=720 are added. The initial load amount of 2400 is needed to code content data and generate a packet to the television set A 403, whereas the load coefficient of 720 is related to a transmission load of the content packet to the television set A 403.

The camera 401 is transmitting Motion-JPEG (SXGA) video data at a frame rate of 10 fps to the television set B 404 as similar to the transmission of the Motion-JPEG (SXGA) video data to the television set A 403. Since a type of the video data transmitted to the television set B 404 matches the type of the video data transmitted to the television set A 403, an initial load amount corresponding to the television set B 404 is not added, whereas a load coefficient of 240 corresponding to the transmission load of 10 fps is added.

The camera 401 is transmitting H.264/AVC (VGA) video data at a frame rate of 30 fps to the mobile terminal A 405. Accordingly, an initial load amount of 1600 and a load coefficient of 30×3=90 are added. The initial load amount of 1600 is needed to code content data and generate a packet to be transmitted to the mobile terminal A 405, whereas the load coefficient of 90 is related to a transmission load of the content packet to the mobile terminal A 405.

Moreover, the camera 401 is transmitting H.264/AVC (VGA) video data at a frame rate of 30 fps to the mobile terminal B 406 as similar to the transmission of the H.264/AVC (VGA) video data to the mobile terminal A 405. Since a type of the video data transmitted to the mobile terminal B 406 matches the type of the video data transmitted to the mobile terminal A 405, an initial load amount corresponding to the mobile terminal B 406 is not added, whereas a load coefficient of 90 corresponding to the transmission load of 30 fps is added.

Therefore, the current total load amount of the camera 401 is 5140 that is the sum of all these amounts.

In the present exemplary embodiment, frame thinning processing is set to be performed if content data coded by the same coding method and having the same resolution but different frame rates is transmitted. However, coding and packet generation may be performed separately for each request having a different frame rate. In such a case, an initial load amount needs to be added separately.

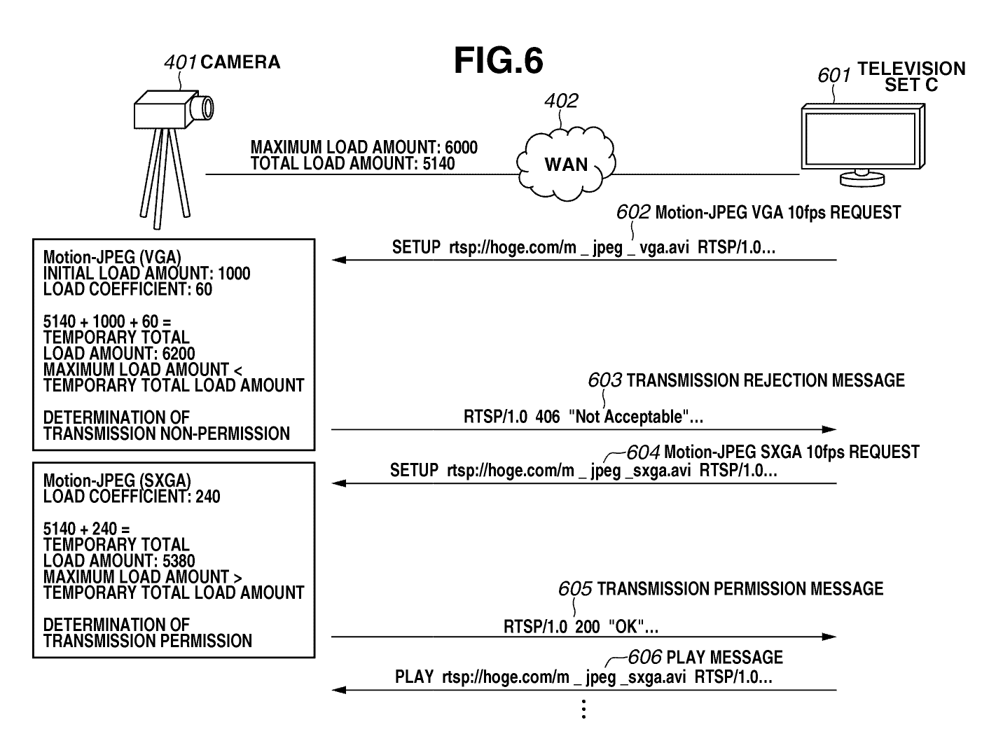

In addition, assume that the camera 401 in the present exemplary embodiment has an allowable load amount of 6000. FIG. 6 illustrates exemplary processing to be performed when a new content request packet is received from the receiving apparatus 102 in such a case.

FIG. 6 illustrates a case where a television set C 601 corresponding to a new receiving apparatus 102 requests Motion-JPEG (VGA) 10 fps using the RTSP.

First, the television set C 601 uses a SETUP message (the content request packet) 602 of the RTSP to request the camera 401 (the transmission apparatus 101) to ensure a resource. The SETUP message 602 has thereinside a uniform resource locator (URL) including type information (m_jpeg_vga.avi) for identifying a type of the content requested to the camera 401.

Upon receipt of the SETUP message 602, the camera 401 refers to the type information included in the URL to identify that a type of the requested content is Motion-JPEG (VGA) 10 fps, and determines a requested-content load amount. The determination of the requested-content load amount corresponds to step S203 illustrated in FIG. 2.

Then, the determination unit 109 of the camera 401 adds the requested-content load amount and the load amounts for the contents being transmitted to the television sets A and B and the mobile terminals A and B, thereby calculating a temporary total load amount.

Since the camera 401 is not transmitting the content packet in Motion-JPEG (VGA) at the time of receipt of the content request packet from the television set C 601, an initial load amount of 1000 and a load coefficient of 60 are added to the current total load amount of 5140. Therefore, the temporary total load amount becomes 6200. Since the camera 401 has the allowable load amount of 6000, the determination unit 109 determines that transmission of the content packet requested by the television set C 601 is not permitted.

The determination unit 109 of the camera 401 transmits a transmission rejection message 603 (the determination result packet) to the television set C 601, and notifies of transmission non-permission for the content packet. The transmission rejection message 603 includes an RTSP Response Code: 406 “Not Acceptable”. When the determination result packet is transmitted, such RTSP Response code may be used, or the RTSP may not be used.

Moreover, the camera 401 of the present exemplary embodiment determines transmission permission/non-permission at the receipt of the SETUP message of the RTSP. However, the camera 401 of the present exemplary embodiment is not limited thereto. For example, transmission permission/non-permission may be determined at a stage of a DESCRIBE message or a PLAY message as long as a type of the content data requested from the receiving apparatus 102 is recognized by the transmission apparatus 101.

Next, a description is given of determination processing of transmission permission/non-permission in a case where the television set C 601 requests Motion-JPEG (VGA) 10 fps by a SETUP message 604 using the RTSP.

The SETUP message 604 (the content request packet) has thereinside an URL including type information (m_jpeg_sxga.avi) for identifying a type of the content requested to the camera 401. Upon receipt of the SETUP message 604, the camera 401 can identify that a type of the requested content is Motion-JPEG (SXGA) 10 fps by referring to the type information included in the URL. The camera 401 determines a requested-content load amount, and then determines (calculates) a temporary total load amount by summation of the requested-content load amount and the current total load amount.

Since Motion-JPEG (SXGA) requested by the television set C 601 is already transmitting to the television set A 403 and the television set B 404, an initial load amount is not added. Therefore, the temporary total load amount becomes 5380, which is determined by addition of the current total load amount of 5140 and the load coefficient of 240 corresponding to the frame rate of 10 fps requested by the television set C 601. Since the temporary total load amount does not exceed the allowable load amount of 6000, the determination unit 109 determines that transmission is permitted.

The camera 401 transmits a transmission permission message 605 to the television set C 601, and notifies of transmission permission for the requested-content data. The transmission permission message 605 includes an RTSP Response Code: 200 “OK”.

Upon notified of the transmission permission for the content data, the television set C 601 requests the camera 401 to start content data transmission. Herein, the request is made through a PLAY message 606 using the RTSP. When the transmission of the content data to the television set C 601 is determined or started, the camera 401 updates the total load amount with the temporary total load amount, and adds “1” to a counter for managing the number of connections for each content data type. The updated total load amount is stored in the memory 115.

If the transmission of the content data stops, the load coefficient of the stopped content data is subtracted from the total load amount, and the counter for managing the number of connections for each content data type is subtracted by “1”.

When the counter becomes zero (0), such zero indicates that a destination of the type of the content data becomes zero. Accordingly, the initial load amount corresponding to the content data type at which the counter becomes zero is subtracted from the total load amount. The total load amount after such subtraction is stored in the memory 115.

The exemplary embodiment has been described with respect to an example case in which there are five receiving apparatuses 102. However, the exemplary embodiment is not limited to such a specific case. Now, other cases where a content request packet is received from one receiving apparatus 102 (a second receiving apparatus) while content data is being transmitted to another receiving apparatus 102 (a first receiving apparatus) will be described below.

First, a description is given as to a case where types of the content data requested by the first receiving apparatus and the second receiving apparatus match each other.

For example, assume that a request for first content data (the frame rate of 30 fps) is received from the second receiving apparatus while video data of Motion-JPEG (SXGA) (first content data) is being transmitted to the first receiving apparatus at a frame rate of 30 fps.

When the types of the content data requested by the respective first and second receiving apparatuses match each other, the determination unit 109 determines whether transmission of the first content data with respect to the second receiving apparatus is permitted. That is, the determination unit 109 determines whether transmission is permitted according to comparison of a total load amount with an allowable load amount. Herein, the total load amount is the sum of a load amount for generation of the first content data, a load amount for transmission of the first content data to the first receiving apparatus, and a load amount for transmission of the first content data to the second receiving apparatus.

Next, a description is given as to a case where coding methods and resolutions among the types of the content data requested by the first receiving apparatus and the second receiving apparatus match each other while frame rates among such types are different.

For example, assume that a request for first content data (the frame rate of 10 fps) is received from the second receiving apparatus while Motion-JPEG (SXGA) (first content data) is being transmitted to the first receiving apparatus at a frame rate of 30 fps.

In such a case, the determination unit 109 determines whether transmission of the first content data with respect to the second receiving apparatus is permitted. That is, the determination unit 109 determines whether transmission is permitted according to comparison of a total load amount with an allowable load amount. Herein, the total load amount is the sum of a load amount for generation of the first content data, a load amount for transmission of the first content data at a frame rate of 30 fps, and a load amount for transmission of the first content data at a frame rate of 10 fps.

Therefore, the transmission apparatus 101 of the present exemplary embodiment quantifies a processing load in consideration of types (e.g., a coding method, a resolution and a frame rate of video, a sampling rate of audio) of the content data requested from the receiving apparatus 102, and determines transmission permission/non-permission. Accordingly, the transmission permission/non-permission can be determined by further reflecting a load of the transmission apparatus.

The present exemplary embodiment has been described with respect to the example case in which a load amount (initial load amount) for content packet generation and a load amount (load coefficient) for content packet transmission are added, so that such an added amount is compared with a threshold value (allowable load amount). However, the present exemplary embodiment is not limited to such a specific case.

For example, if a processor for generating the content packet and a processor for controlling transmission of the content packet are different, a threshold value with respect to an initial load amount and a threshold value with respect to a load coefficient may be stored separately. When any of the initial load amount and the load coefficient exceeds its threshold value, determination can be made so that transmission of the content data is not permitted.

Moreover, the current total load amount of the camera 401 may include a load amount according to camera operation processing such as panning, tilting, or zooming being currently in operation in the camera 401.

A second exemplary embodiment is now described mainly by referring to the difference from the first exemplary embodiment. In the description of the second exemplary embodiment, an amount of generated codes of content data is measured, so that a load coefficient for each type of the content data is dynamically determined.

The present exemplary embodiment is described with reference to an example case in which the camera 401 (the transmission apparatus 101) having a Motion-JPEG encoder and an H.264/AVC encoder statically determines a load coefficient of Motion-JPEG, and dynamically determines a load coefficient of H.264/AVC.

First, the determination unit 109 of the transmission apparatus 101 according to the present exemplary embodiment measures a code amount (a data amount) of the content data coded by H.264/AVC. The determination unit 109 of the present exemplary embodiment measures the code amount (data amount) of the content data by counting the number of packets generated by the packet generation unit 106 in units of GOP.

The determination unit 109 may measure a code amount by counting the number of generated packets in units of another group, or units of time such as 1 second in addition to the units of GOP. Moreover, an amount of coded data output from the data coding unit 105 may be measured instead of the number of generated packets.

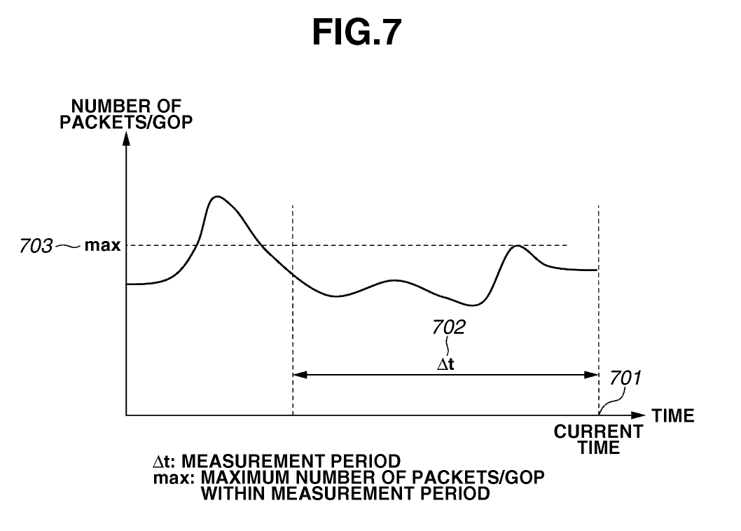

FIG. 7 illustrates an example of a measurement result on the code amount measured by the determination unit 109. In FIG. 7, a horizontal axis indicates time (GOP), whereas a vertical axis indicates the number of packets per GOP.

The determination unit 109 determines a load coefficient using the maximum number of generated packets max 703 in a measurement period Δt 702 that is traced back by a predetermined period from a current time 701. The current time 701 is the time when the load coefficient is determined. The time when the load coefficient is set is in response to reception of a content request packet. The determination unit 109 determines the load coefficient so that the load coefficient should increase as the maximum number of generated packets increases.

Alternatively, the load coefficient may be determined using an average number of packets instead of the maximum number of generated packets. The load coefficient may be determined using the number of packets from the beginning of content data transmission by the transmission apparatus 101 without setting a measurement period. Moreover, the load coefficient may be determined using the number of packets only at the current GOP (the current time 701).

The determination unit 109 determines a load coefficient by multiplication of the maximum number of generated packets max 703 acquired by measurement by a predetermined packet coefficient. The packet coefficient may be the same number regardless of the type of the content data, or may differ depending on the type. For example, a packet coefficient corresponding to a first coding method may be set higher than that corresponding to a second coding method, the first coding method causing a code amount to change easily depending on the presence or absence of movements, whereas the second coding method causing a code amount not to change easily depending on the presence or absence of movements.

That is, the determination unit 109 of the present exemplary embodiment changes the load coefficient (load amount) illustrated in FIG. 5 based on the code amount (data amount) of the measured content data.

There are cases where the total load amount exceeds the allowable load amount due to a change of the load coefficient in dynamic. In such cases, the transmission apparatus 101 of the present exemplary embodiment stops transmission of the content data to one of a plurality of receiving apparatuses 102 being as destinations that last became a destination of the content data.

However, the present exemplary embodiment is not limited thereto. When a total load amount exceeds an allowable load amount due to a change of a load coefficient, for example, the transmission apparatus 101 may reduce a resolution or a frame rate of the content data being transmitted, or may not perform special countermeasures by permitting the total load amount to exceed the maximum load amount.

In the present exemplary embodiment, therefore, an amount of generated codes is measured, so that a load coefficient is dynamically determined. Accordingly, the transmission permission/non-permission can be determined by further reflecting a load of the transmission apparatus even when a coding method causing a large variation in the amount of generated codes is used.

A third exemplary embodiment is now described mainly by referring to the differences from the first and second exemplary embodiments. In the third exemplary embodiment, when a temporary total load amount exceeds a maximum load amount, a data format such as a resolution or a frame rate of the requested content data is changed, so that the determination unit 109 determines whether the content data can be transmitted.

If a temporary total load amount obtained by adding a total load amount and a requested-content load amount exceeds an allowable load amount (YES in step S204 of the flowchart illustrated in FIG. 2), the determination unit 109 of the present exemplary embodiment does not determine promptly that transmission is not permitted. The determination unit 109 determines whether the requested content data can be transmitted if a data format thereof is changed. If the change of the data format causes the transmission of the content data to be permitted, the determination unit 109 transmits a transmission permission message including information on the changed data format to the receiving apparatus 102.

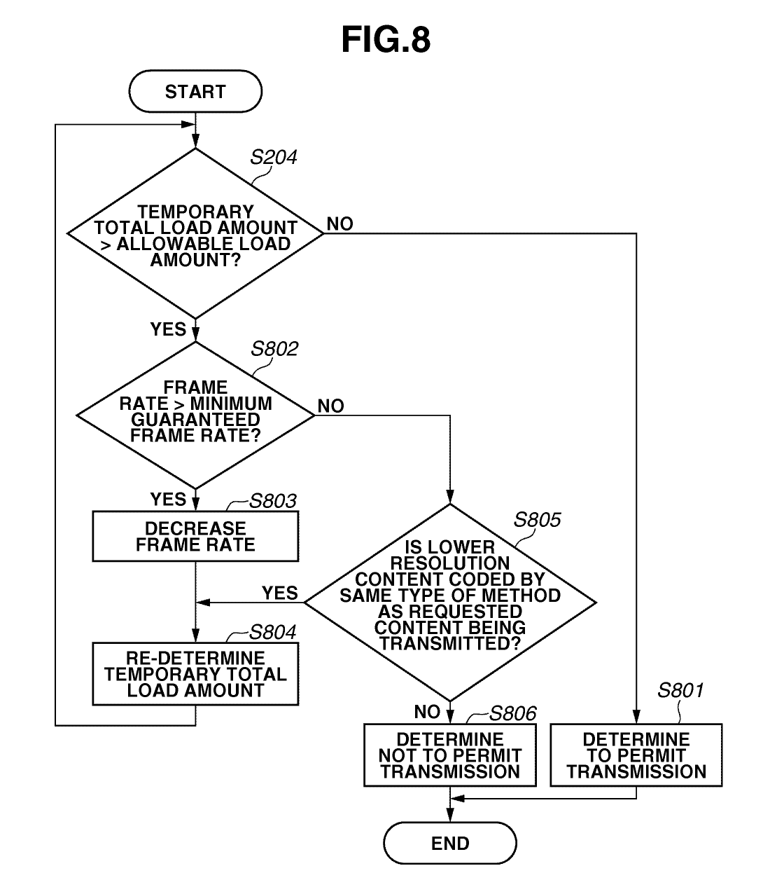

FIG. 8 is a flowchart illustrating exemplary processing for determining whether transmission of the content data is permitted by changing its data format.

The transmission apparatus 101 of the present exemplary embodiment transmits coded content data to the receiving apparatus 102. The transmission apparatus 101 (the camera 401) includes the CPU, which reads out a program for executing the processing illustrated in FIG. 8 to the RAM and executes the program. However, at least one portion of the processing illustrated in FIG. 8 may be performed by dedicated hardware, for example.

The processing illustrated in FIG. 8 corresponds to the processing performed after step S204 illustrated in FIG. 2. That is, the transmission apparatus 101 of the present exemplary embodiment performs the processing from steps S201 to S203 illustrated in FIG. 2 as similar to the first exemplary embodiment.

In step S204, the determination unit 109 determines a temporary total load amount based on the content type information included in the content request packet from the receiving apparatus 102, and compares the temporary total load amount with the allowable load amount.

If the temporary total load amount does not exceed the allowable load amount (NO in step S204), then in step S801, the determination unit 109 determines to permit the transmission, and transmits a determination result packet indicating the transmission permission to the receiving apparatus 102.

On the other hand, if the temporary total load amount exceeds the allowable load amount (YES in step S204), then in step S802, the determination unit 109 compares the frame rate requested from the receiving apparatus 102 with a minimum guaranteed frame rate. If the requested frame rate exceeds the minimum guaranteed frame rate (YES in step S802), then in step S803, the frame rate is decreased. Subsequently, in step S804, the temporary total load amount is re-determined.

In step S803, the frame rate is decreased by a certain amount, although the transmission apparatus 101 of the present exemplary embodiment can decrease the frame rate to the minimum guaranteed frame rate. Accordingly, the transmission apparatus 101 can transmit the content data at a frame rate closer to the request from the receiving apparatus 102.

In step S804, when the temporary total load amount is re-determined, the operation proceeds back to step S204. In step S204, the re-determined temporary total load amount and the allowable load amount are compared. If the re-determined temporary total load amount does not exceed the allowable load amount (NO in step S204), then in step S801, the determination unit 109 notifies the receiving apparatus 102 of the changed frame rate with a determination result indicating that transmission is permitted.

If the frame rate is the minimum guaranteed frame rate (NO in step S802), then in step S805, the determination unit 109 determines whether content data coded by the same coding method as the requested content data but having a lower resolution than the requested content data is being transmitted.

If such content data is being transmitted (YES in step S805), then in step S804, a temporary total load amount is re-determined by using a load amount provided when the resolution is lowered. Subsequently, the operation returns to step S204. If the re-determined temporary total load amount does not exceed the allowable load amount (NO in step S204), the determination unit 109 notifies the receiving apparatus 102 of a transmittable resolution of video data with a determination result indicating that transmission is permitted.

On the other hand, if the content data is not being transmitted (NO in step S805), then in step S806, the determination unit 109 determines not to permit the transmission, and transmits a determination result packet indicating that the transmission is not permitted to the receiving apparatus 102.

The flowchart illustrated in FIG. 8 is merely an example. For another example, a temporary total load amount at a lower resolution may be re-determined (step S805) before a requested frame rate and a minimum guaranteed frame rate are compared (step S802).

Therefore, the transmission apparatus 101 of the present exemplary embodiment determines whether to permit transmission of content data by changing a data format such as a resolution and a frame rate of a requested content when a temporary total load amount in response to a request from the receiving apparatus 102 exceeds an allowable load amount. Accordingly, the determination unit 109 notifies the receiving apparatus 102 of the presence of the content data determined to be transmittable. The determination unit 109 thus can deal with a request from the receiving apparatus 102 in a more flexible manner.

Each of the above exemplary embodiments has been described with respect to the example case in which content is video data, and type information on the content is a coding method, a resolution, and a frame rate of video. However, the exemplary embodiments are not limited to such a case. For example, the content type information may include a compression rate and a setting such as image quality of video (a high quality image, a low quality image).

Moreover, for example, when the transmission apparatus 101 executes an intelligent function such as object detection (human detection), motion detection, desertion detection, removal detection, and loitering detection, the CPU of the transmission apparatus 101 is applied with more load than a case where the intelligent function is not executed.

In such a case, therefore, a predetermined load amount according to a type of the intelligent function executed by the transmission apparatus 101 may be added to the current total load amount so that the added load amount and an allowable load amount may be compared in step S204 of the flowchart illustrated in FIG. 2.

That is, the determination unit 109 adds a load amount according to a type of the intelligent function being executed by the transmission apparatus 101 to a load amount according to type information on the content requested from the receiving apparatus 102. Then, the determination unit 109 compares a threshold value with the added load amount including the load amount according to the intelligent function, and determines whether transmission of the requested content is permitted.

Aspects of the present invention can also be realized by a computer of a system or apparatus (or devices such as a CPU or a micro-processing unit (MPU) which may also be referred to as a microprocessor) that reads out and executes a program recorded on a memory device (computer-readable medium) to perform the functions of one or more of the above-described embodiments, and by a method, the steps of which are performed by a computer of a system or apparatus by, for example, reading out and executing the program recorded on the memory device to perform the functions of one or more of the above-described embodiments. For this purpose, the program can be provided to the computer for example via a network or from a recording medium of various types serving as the memory device (e.g., computer-readable medium). In such a case, the system or apparatus, and the recording medium where the program is stored, are included as being within the scope of the present invention. The computer-readable medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-142996 filed Jun. 28, 2011, which is hereby incorporated by reference herein in its entirety.

What is claimed is:

1. A transmission apparatus comprising:
a transmission unit configured to transmit content data;
a receiving unit configured to receive a type of content data from a receiving apparatus;
a load determination unit configured to determine a load for processing content data of the type received from the receiving apparatus according to a data amount transmitted from the transmission unit for the content data of the type received from the receiving apparatus; and
a transmission determination unit configured to determine whether to transmit the content data of the type received from the receiving apparatus to the receiving apparatus based on the load determined by the load determination unit regarding the content data of the type received from the receiving apparatus.

2. The transmission apparatus according to claim 1, further comprising an acquisition unit configured to acquire a current load of the transmission apparatus,
wherein the transmission determination unit determines whether to transmit the content data of the type received from the receiving apparatus to the receiving apparatus based on the load determined by the load determination unit regarding the content data of the type received from the receiving apparatus and on the load acquired by the acquisition unit.

3. The transmission apparatus according to claim 1, wherein, when a first type of content data is received from the receiving apparatus, the load determination unit determines a load for processing content data of the first type according to a data amount transmitted from the transmission unit for the content data of the first type, and
wherein, when a second type of content data being different from the first type is received from the receiving apparatus, the load determination unit sets a load for processing content data of the second type to a predetermined load.

4. The transmission apparatus according to claim 1, wherein the type includes one of a coding format of content, a resolution of video, and a sampling rate of audio.

5. The transmission apparatus according to claim 1, wherein the load determination unit sets a load applied to generation processing and transmission processing of the content data to a load for processing the content data of the type received from the receiving apparatus.

6. The transmission apparatus according to claim 1, wherein, when content data is being transmitted to a first receiving apparatus, and a transmission request for requesting content data having a type matching a type of the content data being transmitted to be transmitted is received from a second receiving apparatus, the transmission determination unit determines whether to transmit the content data of the type to the second receiving apparatus based on a load for generation of the content data of the type, a load for transmission of the content data of the type to the first receiving apparatus, and a load for transmission of the content data of the type to the second receiving apparatus.

7. The transmission apparatus according to claim 1, wherein, when content data is being transmitted to a first receiving apparatus at a first frame rate, and a transmission request for requesting content data having a type matching a type of the content data being transmitted to be transmitted at a second frame rate is received from a second receiving apparatus, the transmission determination unit determines whether to transmit the content data of the type to the second receiving apparatus based on a load for generation of the content data of the type, a load for transmission of the content data of the type to the first receiving apparatus at the first frame rate, and a load for transmission of the content data of the type to the second receiving apparatus at the second frame rate.

8. The transmission apparatus according to claim 1, wherein, when the content data is determined not to be transmitted, the transmission determination unit determines whether content data of a type being different from a type designated by a received request is transmittable, and
wherein the transmission unit notifies the receiving apparatus of presence of the content data of the type determined to be transmittable by the transmission determination unit, the receiving apparatus having transmitted designation of the type.

9. A transmission control method performed by a transmission apparatus, the transmission control method comprising:
transmitting content data;
receiving a type of content data from a receiving apparatus;
determining a load for processing content data of the type received from the receiving apparatus according to an amount of the transmitted data for the content data of the type received from the receiving apparatus; and
determining whether to transmit the content data of the type received from the receiving apparatus to the receiving apparatus based on the determined load regarding the content data of the type received from the receiving apparatus.

10. The transmission control method according to claim 9, further comprising:
acquiring a current load of the transmission apparatus, and
determining whether to transmit the content data of the type received from the receiving apparatus to the receiving apparatus based on the determined load regarding the content data of the type received from the receiving apparatus and on the acquired load.

11. The transmission control method according to claim 9, further comprising:
determining, when a first type of content data is received from the receiving apparatus, a load for processing content data of the first type according to an amount of the transmitted data for the content data of the first type, and
setting, when a second type of content data being different from the first type is received from the receiving apparatus, a load for processing content data of the second type to a predetermined load.

12. The transmission control method according to claim 9, further comprising, when content data is being transmitted to a first receiving apparatus, and a transmission request for requesting content data having a type matching a type of the content data being transmitted to be transmitted is received from a second receiving apparatus, determining whether to transmit the content data of the type to the second receiving apparatus based on a load for generation of the content data of the type, a load for transmission of the content data of the type to the first receiving apparatus, and a load for transmission of the content data of the type to the second receiving apparatus.

13. The transmission control method according to claim 9, further comprising, when content data is being transmitted to a first receiving apparatus at a first frame rate, and a transmission request for requesting content data having a type matching a type of the content data being transmitted to be transmitted at a second frame rate is received from a second receiving apparatus, determining whether to transmit the content data of the type to the second receiving apparatus based on a load for generation of the content data of the type, a load for transmission of the content data of the type to the first receiving apparatus at the first frame rate, and a load for transmission of the content data of the type to the second receiving apparatus at the second frame rate.

14. A non-transitory computer-readable storage medium storing a program for causing a transmission apparatus to execute a method comprising:
transmitting content data;
receiving a type of content data from a receiving apparatus;
determining a load for processing content data of the type received from the receiving apparatus according to an amount of the transmitted data for the content data of the type received by the receiving apparatus; and
determining whether to transmit the content data of the type received from the receiving apparatus to the receiving apparatus based on the determined load regarding the content data of the type received from the receiving apparatus.

15. The storage medium according to claim 14, wherein the method further comprises:
acquiring a current load of the transmission apparatus; and
determining whether to transmit the content data of the type received from the receiving apparatus to the receiving apparatus based on the determined load regarding the content data of the type received from the receiving apparatus and on the acquired load.

16. The storage medium according to claim 14, wherein the method further comprises:
determining, when a first type of content data is received from the receiving apparatus, a load for processing content data of the first type according to an amount of the transmitted data for the content data of the first type, and
setting, when a second type of content data being different from the first type is received from the receiving apparatus, a load for processing content data of the second type to a predetermined load.

17. The storage medium according to claim 14, wherein the method further comprises, when content data is being transmitted to a first receiving apparatus, and a transmission request for requesting content data having a type matching a type of the content data being transmitted to be transmitted is received from a second receiving apparatus, determining whether to transmit the content data of the type to the second receiving apparatus based on a load for generation of the content data of the type, a load for transmission of the content data of the type to the first receiving apparatus, and a load for transmission of the content data of the type to the second receiving apparatus.

18. The storage medium according to claim 14, wherein the method further comprises, when content data is being transmitted to a first receiving apparatus at a first frame rate, and a transmission request for requesting content data having a type matching a type of the content data being transmitted to be transmitted at a second frame rate is received from a second receiving apparatus, determining whether to transmit the content data of the type to the second receiving apparatus based on a load for generation of the content data of the type, a load for transmission of the content data of the type to the first receiving apparatus at the first frame rate, and a load for transmission of the content data of the type to the second receiving apparatus at the second frame rate.
